(19) United States
(12) Patent Application Publication
(10) Pub. No.: US 2002/0196491 A1
(43) Pub. Date: Dec. 26, 2002

(54) Passive optical network employing coarse wavelength division multiplexing and related methods

(76) Inventors: Kung Li Deng, Monmouth Junction, NJ (US); Chun-Kit Chan, Middletown, NJ (US); Chinlon Lin, Holmdel, NJ (US)

Correspondence Address: Brian K. Dinicola, 34 Avenue E, Monroe Twp, NJ, 08831-2316, US

(21) Appl. No.: 09/888,682

(22) Filed: Jun. 25, 2001

(51) Int. Cl. H04J 14/02; H04B 10/00

(52) U.S. Cl. 359/124; 359/168

(57) ABSTRACT

A passive optical network in which a plurality of wavelength division multiplexed optical signals are exchanged between terminals. At an upstream node such, for example, as a central office, a first plurality of coarsely wavelength division (CWDM) multiplexed optical signals are launched onto or otherwise supplied to a first optical fiber, which fiber may carry optical signals in one or both of the upstream and downstream directions. The downstream or first plurality of coarsely wavelength division multiplexed optical signals, carried via the first optical fiber, are supplied to and distributed by a passive optical node to respective optical network terminals. Each optical network terminal is associated, for example, with a corresponding multiple tenant unit (MTU) such as a commercial office building, a multiple dwelling unit (MDU) such as an apartment, or a fiber to the home (FTTH) grouping of subscribers, and receives at least one of the optical signals from the passive optical node and transmits at least one optical signal to the passive optical node. At the passive node, the optical signals received from the respective optical network terminals are coarsely wavelength division multiplexed again for transmission to the upstream node. The nominal spacing between WDM wavelengths carried over each fiber of the PON is sufficiently great as to obviate temperature stabilized lasers which would otherwise be required at the optical network terminals to avoid cross-talk between adjacent CWDM optical signals.

### BACKGROUND OF THE INVENTION

1. Field of the Invention

The present invention relates generally to the delivery of communication services to subscribers via a communication network and, more particularly, to the transmission of optical signals to individual subscribers or groups of subscribers over a passive optical network.

2. Discussion of the Background Art

The anticipated need for high capacity communication links capable of reaching all the way to the individual subscribers of a communication network has promoted intense interest in broadband transmission over copper cable, wire, wireless, and optical fiber media. Networks in which optical fiber transport is used over substantially the entire path to the subscriber, which may include fiber to the home (FTTH), fiber to the curb (FTTC) and fiber to the multiple tenant unit (FTTMTU) arrangements, hold the greatest promise for meeting this anticipated need for bandwidth. To maximize the information carrying capability of each optical fiber in such networks, and often in order to deliver different services to different subscribers over the same segment(s) of optical fiber, various multiplexing techniques such, for example, as time, wavelength, or sub-carrier frequency multiplexing have been used or considered. A particular class of optical network topologies which continues to receive a considerable amount of investigative attention is the passive optical network (PON).

Essentially, PONs are optical network configurations in which there are no intervening active components between the host digital terminal, central office (CO) or other upstream network node, and customer premises equipment. In other words, a PON requires no active components for directing optical signals between the CO and a network subscriber's terminal equipment. Passive optical networks, therefore, require no power or processing in the field to direct optically encoded information to its destination. Typically, a PON includes a first fiber star formed as a plurality of optical paths extending from the CO to a remote node. Downstream optical signals are transmitted from the CO to the remote node, where the signal is passively split and distributed to one of a plurality of units of network subscriber equipment. The network units may transmit optically encoded signals upstream to the remote node to form a multiplexed signal for distribution to the CO. Lasers are generally used to generate light used to form the transmitted light signals.

A standard PON model is exemplified by FIG. 1, and consists of a first fiber star 1, typically a plurality of optical fibers 2 extending from a central office 4, to one of a plurality of remote nodes 6, i.e., RN1, RN2, . . . RNN. Downstream signals, typically comprising the time division multiplexed output signal λ_{down} of a single, high speed laser 3 modulated at a very high data rate (e.g., on the order of 10 Gb/s), are transmitted from the CO 4 towards each remote node for further distribution. At the remote nodes, light is passively split and distributed via a plurality of optical fibers 8 (a second star) to a plurality of optical network units (ONUS) 10, i.e., ONU-1, ONU-2, . . . ONU-N. The ONUs 10 provide service to the end users wherein each downstream optical signal is received and electronically distributed to all of the end users. The ONUs 10 may transmit upstream signals which are combined at the remote node. Each remote node 6 (or passive star) passively combines transmissions from the ONUs 10 onto a single optical fiber 2 for distribution to the CO.

The two general classes of passive optical network architectures which have heretofore been proposed are a time division multiplexing passive optical network (TDM PON) architecture and a wavelength division multiplexing passive optical network (WDM PON) architecture. In a TDM-PON architecture, a CO broadcasts a downstream optical signal to all ONUs, with each ONU being assigned one or more time slots over which it may transmit and/or receive information. A laser with a common wavelength band, requiring synchronization, may also be used. The obvious advantages of a TDM-PON is that only a single transmitter at the CO is required to serve a substantial number, on the order of 16 to 32 or so, individual subscribers. Additionally, only a single fiber is needed to interconnect the CO to the remote nodes. Unfortunately, however, reliance on the use of time slots does place a limit on the number of users which may be connected to the CO via a remote node. Moreover, because all traffic from a remote node must be transmitted to all ONUs connected to that remote node, the traffic carried over the interconnecting fiber, as fibers 8 in FIG. 1, tends to be asymmetric. That is, in the downstream direction, the data rate output by a single laser transmitter may be on the order of 10 Gb/s while in the upstream direction, each individual subscribers may transmit on the order of about 155 Mb/s.

Wavelength division multiplexing (WDM) is a technology in which multiple wavelengths share the same optical fiber in order to increase the capacity and configurability of networks. WDM generally increases optical system capacity by simultaneously transmitting data on several optical carrier signals at different wavelengths. A WDM PON utilizes an architecture, such as the one shown in FIG. 2, within which each ONU serves an individual subscriber and is assigned a unique wavelength by the central office. Signals destined for each remote node (and ultimately, each optical network unit) are created by modulating light at N distinct wavelengths at the central office CO 12. The modulated light is multiplexed onto a fiber directed to the remote node. The downstream signals are split and distributed to the ONU as a function of wavelength within a wavelength division demultiplexer or WDM splitter 14 at the remote node. In the upstream transmission direction (optical network unit to remote node), the light is transmitted at assigned wavelengths, typically by a laser.

Compared to TDM PONs, WDM PONs have the advantage that they do not broadcast individual subscribers' data to all premises. As a result, privacy is enhanced and the electronics in the ONU need only operate at the subscriber's data rate. However, upstream transmission through a wavelength routing device can be difficult. Owing to the large number of wavelengths which must be carried by the fibers in the WDM PON, they tend to be very closely spaced—on the order of 0.8 nm. As such, it is necessary to employ temperature controlled single frequency lasers at each ONU to avoid transmission penalties such as crosstalk between adjacent wavelengths. Unfortunately, such lasers are so expensive that the WDM PON has heretofore remained too costly a proposal for widespread acceptance by network operators. Other barriers to mass-market deployment have included the lack of a commercially available multichannel laser diode, for use at the CO. Such laser diodes have proven very difficult to fabricate, with acceptable yield, even with as few as eight channels. In addition, passive WDM splitters currently available have a large temperature variation of their passband channels, thereby requiring a continuous tunability in the multichannel sources that has not yet been achieved.

In a so-called hybrid WDM-TDM PON architecture, shown in FIG. 3, multiple wavelengths λ₁-λ_{N} are launched at the CO into a single fiber by which they are supplied to a WDM splitter or passive, fiber-based router which separates them into the constituent individual wavelengths. Each of the thus demultiplexed optical signals is, in turn, supplied over a corresponding fiber to an optical network terminal (ONT) which serves multiple subscribers and/or multiple ONUs using its assigned wavelength by, as in the pure TDM case, communicating with each ONU over one or more assigned time slots. As will be readily appreciated by those skilled in the art, each ONU may serve more than one subscriber, as in a Fiber to the Curb (FTTC) arrangement, or may correspond to only one subscriber, as in a Fiber to the Home (FTTH) arrangement. Of each of the various architectures, the hybrid PON is especially attractive since for a given number of subscribers it allows the network owner or operator to use a smaller number of wavelengths than in a pure WDM PON. Like the pure WDM PON arrangement, however, the cost of temperature stabilized lasers, necessitated by limitations in the temperature variation of the passband channels in the passive WDM splitters, has heretofore limited the commercial attractiveness of the hybrid WDM-TDM architecture.

Although the art of transmitting data from a central office to a remote unit is well developed, a need continues to exist for a commercially practical system and method by which optical signals may be reliably delivered to individual subscribers and in which the bandwidth constituted by wavelength division multiplexed signals carried by each individual optical fibers are efficiently and flexibly allocated to those subscribers.

### SUMMARY OF THE INVENTION

The aforementioned needs are addressed, and an advance is made in the art, by a passive optical network in which a plurality of coarsely wavelength division multiplexed optical signals are exchanged between terminals. An upstream node, which depending on the network, may be a central office, data center, head-end, hub, point of presence or local exchange, supplies a first plurality of coarsely wavelength division multiplexed optical signals onto a first optical fiber. A passive optical node receives the first plurality of coarsely wavelength division multiplexed optical signals from the upstream node, demultiplexes them, and distributes them to corresponding optical network terminals.

A first optical network terminal optically coupled to the passive optical node includes a transceiver for receiving at least a first one of the coarsely wavelength division multiplexed optical signals, at a first wavelength, from the passive optical node over a second optical fiber and for transmitting at least a first one of a second plurality of coarsely wavelength division multiplexed optical signals, at a second wavelength, to the upstream node via the passive optical node.

A second optical network terminal optically coupled to the passive optical node includes a transceiver for receiving at least a second one of the coarsely wavelength division multiplexed optical signals, at a third wavelength, from the passive optical node over a third optical fiber and for transmitting at least a second one of the second plurality of coarsely wavelength division multiplexed optical signals, at a fourth wavelength, to the upstream node via the passive optical node. The first and second ones of the second plurality of coarsely wavelength division multiplexed optical signals are launched onto a single optical fiber at the passive node.

In accordance with an Illustrative embodiment of the passive optical network of the present invention, once optical signals originating at each optical network terminal are coarsely wavelength division multiplexed at the passive optical node and launched onto the first optical fiber. However, in accordance with an especially preferred form of the invention, the latter coarsely wavelength division multiplexed optical signals are launched by the passive node onto a separate or fourth fiber for transmission to the upstream node. Illustratively, the passive optical node may comprise a 2×N passive wavelength router employing fiber mux/demux construction. In such a device, optical signals arriving on the first fiber (for downstream transmission) are progressively separated into sub bands until they are separated as desired for transmission to the optical network terminals associated with a passive node. Conversely, optical signals arriving from the optical terminals for upstream transmission are progressively aggregated until all arriving optical signals have been coarsely wavelength division multiplexed for transmission to the upstream node.

A principal objective of the invention is to realize a passive optical network which can be deployed at a capital cost attractive to owners and operators of communication networks. Because the present invention preferably employs a coarse WDM transmission technique in both the upstream and the downstream invention, inexpensive, non-thermally stabilized lasers may advantageously be used at the optical network nodes and, if applicable, the upstream node(s). Illustratively, the wavelengths of adjacent CWDM signals transmitted over the fibers coupling the optical network terminals to the passive optical node (as well as on the fibers coupling the passive optical node to the upstream node) may be nominally separated by a spacing of about 15 to 20 nm when the transmit lasers are being operated within their standard operating temperature range—with a spacing of 20 nm being deemed by the inventors herein to be sufficiently reliable for most installations. It will, however, be readily appreciated by those skilled in the art that although the actual spacing may differ substantially—particularly as transmit laser manufacturing and packaging techniques improve—the aforementioned objective is met when the adjacent transmit wavelengths, within the band of wavelengths encompassing the CWDM signals, are spaced sufficiently as to avoid transmission penalties (e.g., crosstalk) despite variations in the operating temperature of the respective transmit lasers.

The CWDM PON topology of the present invention is especially cost effective when the individual subscribers are tenants of a multiple tenant unit (MTU) such as an apartment building, commercial office buildings, hotels. In such an environment, a single optical network terminal might be configured to serve a substantial number of individual subscribing entities merely by exchanging signals with those entities over respectively assigned time slots. Such a topology, moreover, may be obtained by means of an overlay or adaptation of an existing TDM PON network or even a hybrid fiber coax (HFC) network heretofore only used to provide video broadcast services to subscribers. Although the upstream nodes of such legacy networks typically utilize fiber optimized for transmission of optical transmit and receive signals of only a single wavelength in each of the upstream and downstream directions, the actual wavelength bands which can be accommodated are much broader and it is therefore possible, in accordance with the teachings of the present invention, to insert additional structure, such as WDM couplers and optical passband filters so as to separately process additional, coarsely wavelength division multiplexed optical signals in both the upstream and downstream directions.

Other objects, advantages, and features of the invention will become apparent from the detailed description taken in conjunction with the annexed drawings, which depict illustrative embodiments of the invention.

### BRIEF DESCRIPTION OF THE DRAWINGS

The invention will be described with reference to the following drawings in which like reference numerals refer to like elements and wherein:

FIG. 1 is a diagram showing a conventional time division multiplexed passive optical network (TDM-PON) network;

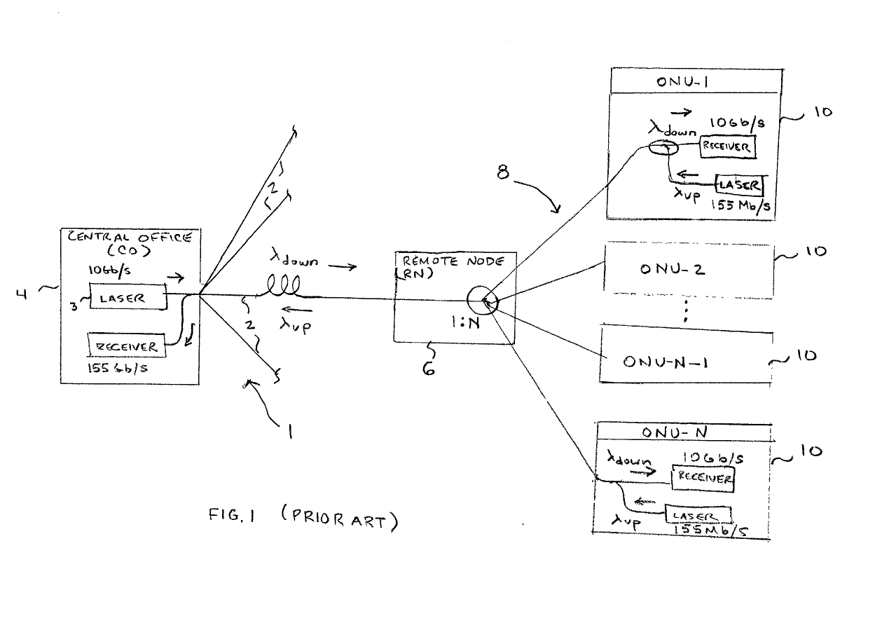

FIG. 2 is a diagram showing a conventional wavelength division multiplexed passive optical network (WDM-PON);

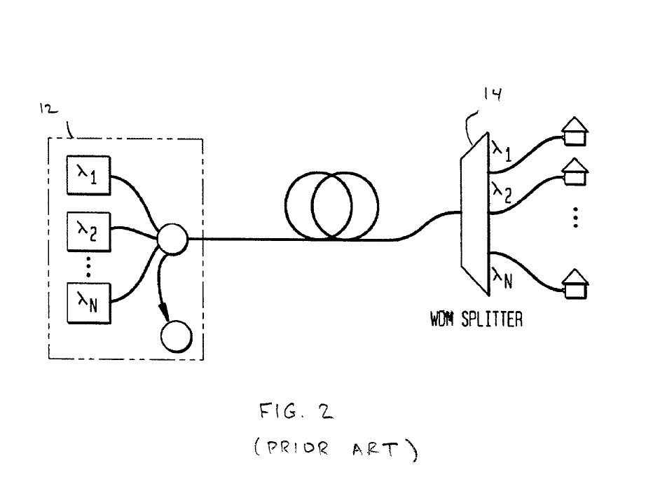

FIG. 3 is a diagram showing a conventional hybrid TDM-WDM passive optical network (hybrid PON);

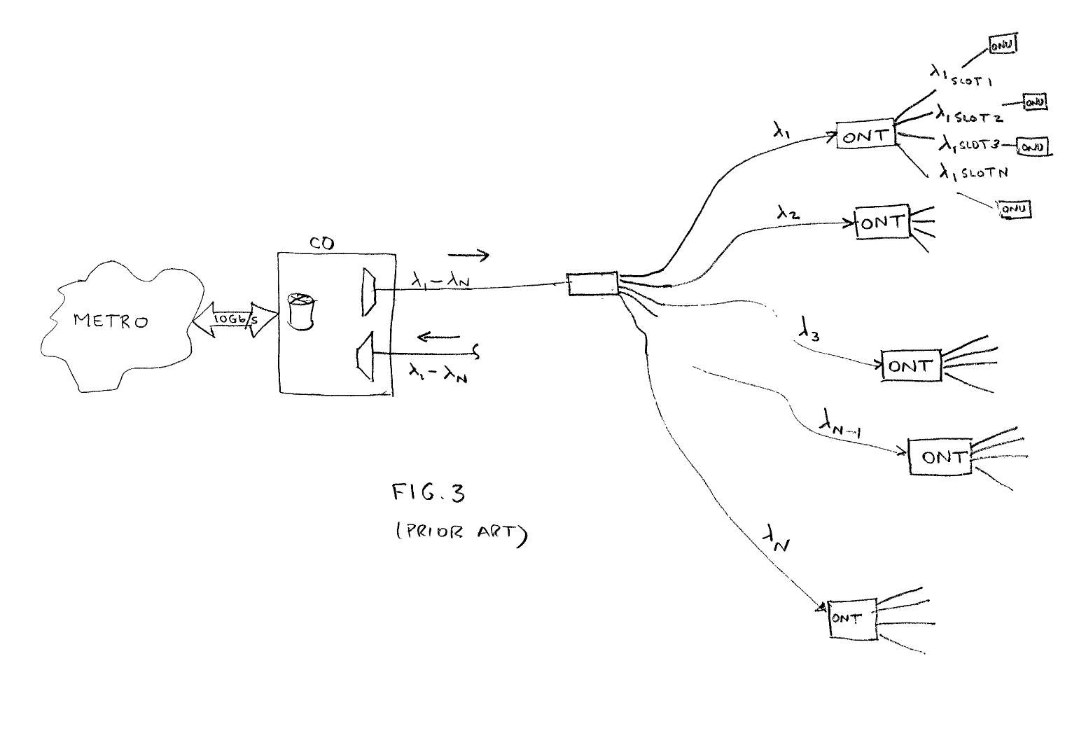

FIG. 4 is a diagram showing a hybrid PON employing coarse WDM wavelength spacing and a passive wavelength routing element in accordance with an illustrative embodiment of the present invention; and

FIG. 5 is a diagram depicting the manner in which the hybrid PON architecture of the present invention may be achieved as an overlay within an existing TDM or Telephony PON in which TDM optical signals are transmitted bi-directionally over respective individual fibers.

### DETAILED DESCRIPTION OF THE INVENTION

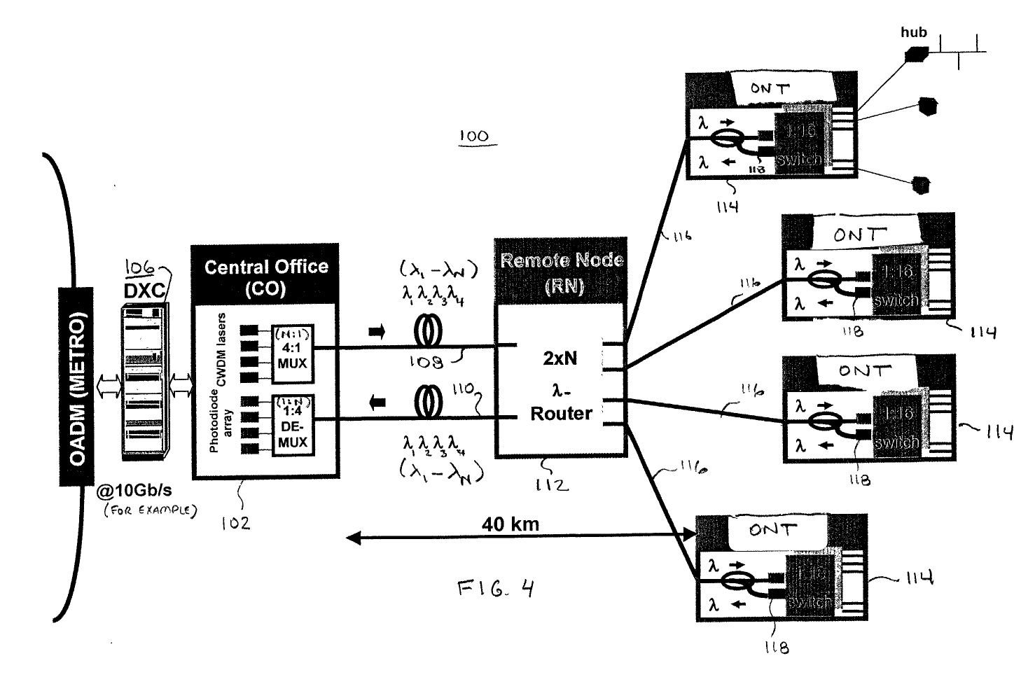

With initial reference to FIG. 4, there is shown a coarsely wavelength division multiplexed, hybrid passive optical network (CWDM-PON) 100 constructed in accordance with an illustrative embodiment of the invention. As seen in FIG. 4, CWDM PON 100 includes an upstream node generally indicated at 102. Depending upon the nature and scope of communication services to be provided to subscribers by CWDM-PON 100, upstream node 102 may be a central office, as for example, one might find in a conventional TDM telephony PON, a head-end or hub, as one might find in a hybrid fiber coax CATV network, or perhaps a data center, point of presence or local exchange. In the illustrative embodiment of FIG. 4, upstream node 102 is configured as a central office (CO) exchanging communication signals with a metropolitan area network (not shown) via an optical add/drop multiplexer 104 and an associated digital cross connect 106.

Although in the exemplary architecture depicted in FIG. 4, the signals exchanged between upstream node 102 and the metropolitan area network are converted from optical to electrical and back again to optical, it should be noted that the teachings of the present invention are equally applicable to all optical networks in which no electrical conversion is needed for aggregation and routing of the constituent information signals. In any event, and with continued reference to FIG. 4, it will be seen that each signal received from cross connect 106 corresponds to a respective coarsely wavelength division multiplexed optical signal to be routed to subscribers downstream via a plurality of fibers. For clarity and ease of explanation, only one fiber in each direction (to and from upstream node 102)—indicated generally at 108 and 110, respectively, is shown representing connection to a single illustrative remote node (RN) 112 serving a corresponding group of passive optical network terminals (ONTs) 114 which, in turn, each serve a corresponding plurality of subscribers. It should be emphasized, then, that many more such remote nodes as remote node 112 may be optically coupled to upstream node by corresponding optical links, and that although separate fibers as fibers 108 and 110 are shown for transmission in both the upstream and downstream directions, the same functionality might be realized via bi-directional transmission over a single, shared optical fiber link.

In any event, and as seen in FIG. 4, a first plurality of WDM optical signals within an optical wavelength band of optical fiber 108 are transmitted over optical fiber 108 in the downstream direction toward remote node 112. Likewise, a second plurality of WDM optical signals within the optical wavelength band of optical fiber 110 are transmitted from remote node 112 toward upstream node 102. Each plurality of CWDM optical signals employs N optical wavelengths, and these wavelengths may, but need not be, the same in both upstream and downstream directions. By way of illustrative example, in an eight wavelength system, λ₁-λ₈ may be transmitted in the downstream direction over fiber 108 and λ₁-λ₈ may, at the same time, be transmitted in the upstream direction over fiber 110. In the illustrative network shown in FIG. 4, a respective one of four wavelengths (λ₁-λ₄) supplied via fiber 108 is transmitted from the remote node RN 112 to a corresponding ONT 114 via a dedicated fiber link 116. As well, each fiber link 116 is configured, for transmission in the upstream direction, to direct optical signals originating at a corresponding ONT 114 to RN 112.

Because CWDM-PON 100 is a passive optical network, each remote node as remote node 112 must demultiplex the WDM signals received from upstream node 102 without the use of costly active components and distribute them to the appropriate individual subscribers via ONTs 114. With respect to both the upstream and downstream transmission directions, in order to further reduce the costs of deployment of the network (to a commercially attractive level), it is also desirable to avoid the use of expensive, thermally stabilized lasers at both upstream node 102 and in the respective ONT transmitters 118. Because optical network terminals such as ONTs 114 are often installed in areas where the ambient operating temperatures are subject to frequent, broad ranging variations (on the order of from −10° C. to 70° C.), it has heretofore been considered a necessity to utilize such thermally stabilized lasers in order to avoid cross talk and other transmission penalties between the respective optical signals once they are wavelength division multiplexed onto a single fiber. That is, in the absence of such stabilization, the output wavelength of each laser transmitter has a tendency to drift in such a way as to create the potential to cause optical signals traversing a fiber (whether co-propagating, as in the case of links 108 and 110, and counter-propagating, as exemplified by bi-directional fiber links 116) to interfere with one another. By way of illustrative example, a multiple quantum well (mQW) laser structure constructed from a material such as GaAs or InGaAsaP may exhibit a drift in excess of 0.1 nm/° C.

The need for thermally stabilized lasers is avoided, in accordance with the present invention, by employing coarse wavelength division multiplexing. That is, the constituent nominal transmit wavelengths selected for transmission by the transmitters of upstream node 102 and ONTs 114 are sufficiently spaced from one another as to avoid transmission penalties, during propagation (or counter-propagation, as the case may be) of the optical signals over a corresponding single optical fiber, despite variations and fluctuations in the operating temperature of each laser transmitter as ONT laser transmitters 118. Excellent results, for example, have been achieved using a minimum wavelength spacing of 20 nm for co-propagating WDM optical signals transmitted over a unidirectional fiber as fiber 108 or 110, and a minimum wavelength spacing of 40 nm between counter propagating optical signals transmitted over a bidirectional fiber as fiber 116.

Of course, it will be readily appreciated that although the use of a respective bidirectional fiber link 116 between RN 112 and each corresponding ONT 114 is especially preferred by the inventors herein for the purpose of minimizing the fiber count and thus deployment costs, it is equally possible to use a pair of unidirectional fiber links (not shown) in its place. In such event, the same wavelength spacing employed on fibers 108 and 110 (e.g., 20 nm) should suffice. It should also be mentioned that although a minimum nominal transmit wavelength spacing of 20 nm between co-propagating transmit wavelengths and 40 nm between counter-propagating transmit/receive wavelengths is recommended by the inventors herein as it permits the use of commercially available, inexpensive, non-thermally stabilized lasers, closer spacings of say 15 nm and 30 nm, respectively, may also be effective for most operating environments. Moreover, as transmit laser technology improves it may be possible to move the nominal laser transmit wavelengths even closer together. In either case, what is important to remember is that the nominal transmit wavelengths of each transmit laser should be spaced sufficiently far as to avoid transmission penalties over the same fiber despite temperature dependent fluctuations in the output transmit wavelength of each ONT laser.

From the foregoing, it will be understood that each ONT 114 receives its designated CWDM signal from RN 112, via a dedicated fiber link 116. By way of illustrative example, fiber link 116 may carry a single WDM channel modulated at a data rate of, say, 2.5 Gb/s for gigabit Ethernet applications (GbE). Depending upon the needs of the subscribers associated with a particular ONT, a flexible suite of data and/or voice communication services may be provided by the owner or operator of the CWDM-PON of the present invention. Illustratively, the downstream WDM channel may be time division multiplexed using a 1:N switch to provide a plurality of lower rate data channels to the respective subscribers. Thus, for example, a 1:16 switch might be configured in the downstream direction to divide the WDM channel into 16 TDM time slots, each carrying 155 Mb/s. Likewise, in the upstream direction, the aggregated traffic originating from each of these subscribers may also be received via transmission over assigned time slots and passed to an N:1 (e.g., 16:1) switch and transmitted to the upstream node, for appropriate routing, as the upstream WDM channel received by RN 112 via the ONT transmitter 116.

The CWDM PON topology of the present invention is especially cost effective when the individual subscribers are tenants of a multiple tenant unit (MTU) such as an apartment building, commercial office buildings, hotels. In such an environment, a single optical network terminal might be configured to serve a substantial number of individual subscribing entities merely by exchanging signals with those entities over respectively assigned time slots. Such a topology, moreover, may be obtained by means of an overlay or adaptation of an existing TDM PON network or even a hybrid fiber coax (HFC) network heretofore only used to provide video broadcast services to subscribers. Although the upstream nodes of such legacy networks typically utilize fiber optimized for transmission of optical transmit and receive signals of only a single wavelength in each of the upstream and downstream directions, the actual wavelength bands which can be accommodated are much broader and it is therefore possible, in accordance with the teachings of the present invention, to insert additional structure, such as WDM couplers and optical passband filters so as to separately process additional, coarsely wavelength division multiplexed optical signals in both the upstream and downstream directions.

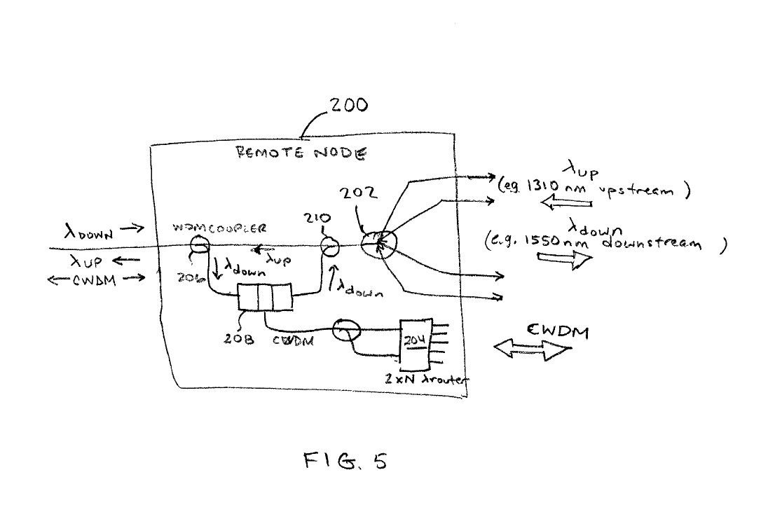

The various advantages which can be realized in accordance with the present invention, by modifying an existing network to obtain a CWDM-PON topology, may be better appreciated by reference to FIG. 5. Essentially, FIG. 5 depicts the deployment of several components within an existing remote node 200 of the type that might be found in a conventional hybrid fiber coax (HFC) CATV network. As will be readily appreciated by those skilled in the art, in a HFC network, optical signals originating at a head end (not shown) are distributed to secondary hub nodes from which fibers carrying optical signals (typically at a single wavelength) extend. In an HFC network, each fiber may be passively split, as by power splitter 202, many times before reaching a downstream node (not shown) in which electrical conversion is performed and the thus converted broadcast signals are transmitted over coaxial cable to the homes of individual subscribers. In the network exemplified by FIG. 5, the fiber carries optical signals over a first or downstream wavelength λ_{down} at 1550 nm, commonly selected because it is centered in the wavelength band suitable for C-Band EDFA amplification. Optionally, and as exemplified in FIG. 5, the network may also be configured to receive optical signals from the individual subscribers. Such signals are shown being transmitted by a second or upstream wavelength λᵤₚ at 1310 nm, commonly selected because it is centered in a wavelength band sufficiently far from the wavelength band of the first wavelength as to avoid transmission penalties. As will be readily appreciated by those skilled in the art, transmission in the downstream direction is typically at a rate many times higher than the transmission in the upstream direction so that the traffic carried by such a network is said to be asymmetric.

In any event, and with continued reference to FIG. 5, it will be seen that also added to remote node 200 is a passive wavelength router 204 configured to demultiplex additional coarsely wavelength division multiplexed optical signals introduced at an upstream node such as at the head end (not shown) in accordance with the present invention. Although at least some of the CWDM optical signals are in the same wavelength band as λ_{down,} (i.e., the C-band) depending upon the total number of channels required, it is especially preferred by the inventors herein to make use of the so-called L-band as well. As will be readily appreciated by those skilled in the art, this serves to purposes. First, it allows a larger number of channels in each direction of transmission. Second, it allows a wider nominal spacing between these channels.

To separate λ_{down} from the CWDM channels, a first WDM coupler 206 is used to separate the first and second wavelength bands carrying λ_{down} and λᵤₚ, respectively. Then, a passive drop filter 208 separates λ_{down} from the CWDM signals and a second WDM coupler 210 restores λ_{down} to its originally path along the distribution fiber. In every other respect, the processing and distribution of λ_{down} (as well as λᵤₚ) is undisturbed and the operation of the existing network with respect to these signals may therefore continue without alteration or significant interruption of service to pre-existing subscribers. Processing of the CWDM optical signals by the wavelength router 204 within remote node 200, moreover, proceeds in accordance with the techniques and operation generally discussed with the embodiment of FIG. 4.

As the purpose of the overlay process is to introduce additional services to groups of subscribers, it is also necessary to connect respective optical network terminals to corresponding outputs of passive wavelength router 204. As in the embodiment of FIG. 4, each optical network terminal has a transceiver for receiving at least one of the demultiplexed CWDM optical signals from wavelength router 204, at wavelengths respectively different from λ_{down} and from one another. The transceiver of each optical network terminal (not shown) is further adapted to transmit at a CWDM wavelength channel which is different from other CWDM wavelength channels exiting passive wavelength router in the upstream direction. As discussed earlier, by selecting wavelength channels of appropriate nominal spacing, transmission performance penalties are avoided despite the use of non-thermally stabilized transmit lasers in the optical network terminals.

It is to be understood that the above described embodiments are merely illustrative of the principles of the invention. Various modifications and changes may be made thereto by those skilled in the art which will embody the principles of the invention and fall within the spirit and scope thereof.

What is claimed is:

1. In a passive optical network for exchanging a plurality of wavelength division multiplexed optical signals between terminals thereof,
an upstream node supplying a first plurality of coarsely wavelength division multiplexed optical signals onto a first optical fiber;
a passive optical node, said passive optical node distributing said first plurality of coarsely wavelength division multiplexed optical signals to corresponding optical network terminals;
a first optical network terminal having a transceiver for receiving at least a first one of said coarsely wavelength division multiplexed optical signals, at a first wavelength, from the passive optical node over a second optical fiber and for transmitting at least a first one of a second plurality of coarsely wavelength division multiplexed optical signals, at a second wavelength, to the upstream node via said passive optical node; and
a second optical network terminal having a transceiver for receiving at least a second one of said coarsely wavelength division multiplexed optical signals, at a third wavelength, from the passive optical node over a third optical fiber and for transmitting at least a second one of the second plurality of coarsely wavelength division multiplexed optical signals, at a fourth wavelength, to the upstream node via said passive optical node, wherein the first and second ones of the second plurality of coarsely wavelength division multiplexed optical signals are launched onto a single optical fiber at said passive node.

2. The passive optical network of claim 1, wherein optical signals originating at each said optical network terminal are coarsely wavelength division multiplexed at the passive optical node and launched onto the first optical fiber.

3. The passive optical network of claim 1, wherein optical signals originating at each said optical network terminal are coarsely wavelength division multiplexed at the passive optical node and launched onto a fourth optical fiber.

4. The passive optical network of claim 1, wherein the passive optical node is a 2×N passive wavelength router having a first port for receiving said first plurality of coarsely wavelength division multiplexed optical signals from an upstream node of said network and a second port for directing said second plurality of coarsely wavelength division multiplexed optical signals from said first and second optical network terminals to the upstream node.

5. The passive optical network of claim 4, wherein said first fiber is optically coupled between said first port and the upstream node and wherein a fourth fiber is optically coupled between said second port and the upstream node.

6. The passive optical network of claim 1, wherein said first wavelength and said third wavelength have a nominal spacing of from about 15 nm to about 20 nm when a transmit laser originating each of said first and third wavelengths is operating at a normal ambient temperature, and wherein said second wavelength and said fourth wavelength have a nominal spacing of from about 15 nm and about 20 nm when a transmit laser originating each of said second and fourth wavelengths is operating at a normal ambient temperature.

7. The passive optical network of claim 6, wherein said first wavelength and said second wavelength have a nominal spacing of from about 30 nm to about 40 nm.

8. The passive optical network of claim 1, wherein said first optical network terminal is disposed at a multiple tenant unit building serving a plurality of subscribers, said first optical network terminal being adapted to exchange signals with each said subscriber over one or more respective assigned time slots.

9. The passive optical network of claim 1, wherein adjacent wavelengths of optical signals within each respective plurality of coarsely wavelength division multiplexed optical signals have a spacing sufficient to substantially avoid transmission penalties during transmission over a corresponding single optical fiber despite variations in operating temperature of said laser.

10. A passive optical network for exchanging a plurality of wavelength division multiplexed optical signals between terminals thereof, comprising,
an upstream node supplying a first plurality of coarsely wavelength division multiplexed optical signals onto a first optical fiber;
a passive optical node, said passive optical node distributing said first plurality of coarsely wavelength division multiplexed optical signals to corresponding optical network terminals; and
a plurality of optical network terminals each having a receiver for receiving at least a corresponding one of said first plurality of coarsely wavelength division multiplexed optical signals from the passive optical node over a corresponding optical fiber and a non-temperature stabilized laser for transmitting at least a corresponding one of a second plurality of coarsely wavelength division multiplexed optical signals to the upstream node via said corresponding optical fiber, adjacent wavelengths of optical signals within each respective plurality of coarsely wavelength division multiplexed optical signals having a spacing sufficient to substantially avoid transmission penalties during transmission over a corresponding single optical fiber despite variations in operating temperature of said laser.

11. The passive optical network of claim 10, wherein optical signals from said plurality of optical network terminals are coarsely wavelength division multiplexed and launched onto a single optical fiber, as said second plurality of coarsely wavelength division multiplexed optical signals, at said passive node.

12. The passive optical network of claim 11, wherein said single optical fiber at said passive node is not the first optical fiber.

13. The passive optical network of claim 10, wherein a nominal spacing between adjacent wavelengths of optical signals in said first plurality of coarsely wavelength division multiplexed optical signals is from about 15 nm to about 20 nm when transmit lasers originating adjacent ones of said first plurality of coarsely wavelength division multiplexed optical signals are being operated at standard operating temperature.

14. The passive optical network of claim 10, wherein a nominal spacing between adjacent wavelengths of optical signals in said second plurality of coarsely wavelength division multiplexed optical signals is from about 15 nm to about 20 nm when transmit lasers originating adjacent ones of said second plurality of coarsely wavelength division multiplexed optical signals are being operated at standard operating temperature.

15. The passive optical network of claim 10, wherein said optical network terminal is disposed at a multiple tenant unit building serving a plurality of subscribers, said optical network terminal being adapted to exchange signals with each said subscriber over one or more respective assigned time slots.

16. A method of operating a passive optical network, comprising the steps of:
at an upstream node, supplying a first plurality of coarsely wavelength division multiplexed optical signals onto a first optical fiber;
at a passive optical node, distributing the first plurality of coarsely wavelength division multiplexed optical signals to corresponding optical network terminals;
receiving, at a first optical network terminal, at least a first one of said coarsely wavelength division multiplexed optical signals, at a first wavelength, from the passive optical node over a second optical fiber;
transmitting, from the first optical network terminal, at least a first one of a second plurality of coarsely wavelength division multiplexed optical signals, at a second wavelength, to the upstream node via said passive optical node;
receiving, at a second optical network terminal, at least a second one of said coarsely wavelength division multiplexed optical signals, at a third wavelength, from the passive optical node over a third optical fiber; and
transmitting, from the second optical network terminal, at least a second one of a second plurality of coarsely wavelength division multiplexed optical signals, at a fourth wavelength, to the upstream node via said passive optical node.

17. The method of claim 16, wherein optical signals transmitted by said optical network terminals are coarsely wavelength division multiplexed at the passive optical node and launched onto an optical fiber other than the first optical fiber.

18. The method of claim 16, further including a step of deploying the first optical network terminal at a multiple tenant unit building serving a plurality of subscribers, and exchanging signals with each said subscriber over one or more respective assigned time slots.

19. The method of claim 16, wherein optical signals transmitted by the first optical network terminals are carried by the second fiber to the passive optical node.

20. A method of upgrading an existing passive optical communication network, in which information signals at a first wavelength within a first wavelength band and originating at an upstream node are transmitted downstream to individual subscribers and in which information signals at a second wavelength band and originating with at least some of the individual subscribers are transmitted to the upstream node, said method comprising the steps of:
at a remote node, providing means for separating the first wavelength from the first wavelength band;
providing a passive wavelength router to demultiplex coarsely wavelength division multiplexed (CWDM) optical signals within said first wavelength band and to distribute the demultiplexed CWDM optical signals to corresponding outputs;
connecting a first optical network terminal to an output of the passive wavelength router, said first optical network terminal having a transceiver for receiving at least a first one of the demultiplexed CWDM optical signals, at a third wavelength, from the passive optical node over a second optical fiber and for transmitting, at a fourth wavelength, at least a first one of a second plurality of coarsely wavelength division multiplexed optical signals within the first wavelength band; and
connecting a second optical network terminal to an output of the passive wavelength router, said second optical network terminal having a transceiver for receiving at least a second one of the demultiplexed CWDM optical signals, at a fifth wavelength, from the passive optical node over a third optical fiber and for transmitting at least a second one of the second plurality of coarsely wavelength division multiplexed optical signals, at a sixth wavelength, to the upstream node.

21. The method of claim 20, wherein the first wavelength band is centered at about 1550 nm and wherein the second wavelength band is centered at about 1310 nm.

22. The method of claim 20, wherein said existing passive optical network is a telephony time division multiplexed PON.

23. The method of claim 20, wherein said existing passive optical network is a hybrid fiber coaxial cable communication network.

24. The method of claim 20, wherein the step of connecting said first optical network terminal is performed at a multiple tenant unit building serving a plurality of subscribers, said first optical network terminal being adapted to exchange signals with each said subscriber of said multiple tenant unit building over one or more respective assigned time slots.

25. The method of claim 20, wherein the passive wavelength router is a fiber-based multiplexer/demultiplexer.

26. For use in a passive optical communications network in which a plurality of coarsely wavelength division multiplexed (CWDM) optical signals within a wavelength band are directed to a passive node for demultiplexing,
an optical network terminal having a receiver adapted to receive a first CWDM optical signal launched by a remote laser operating at a first nominal wavelength , within the wavelength band, from the passive mode and having a non thermally stabilized laser operating at a second nominal wavelength to produce a second CWDM signal, within the wavelength band, to the upstream node, a wavelength spacing between the first nominal wavelength and the second nominal wavelength being sufficient to substantially avoid transmission penalties during counter-propagating transmission over a single optical fiber despite variations in operating temperature of said non-thermally stabilized laser.

27. The optical network terminal of claim 26, wherein the first CWDM optical signal and the second CWDM optical signal are separated by at least 30 nm when said non-thermally stabilized laser is operating at a standard operating temperature.

28. The optical network terminal of claim 27, wherein the first CWDM optical signal and the second CWDM optical signal are separated by 40 nm when said nonthermally stabilized laser is operating at a standard operating temperature.
